(19) United States
(12) Patent Application Publication
(10) Pub. No.: US 2019/0215717 A1
(43) Pub. Date: Jul. 11, 2019

(54) COMMUNICATION DEVICE, PROCESSING DEVICE AND METHOD FOR TRANSMITTING BUFFER STATUS REPORT

(71) Applicant: LG ELECTRONICS INC., Seoul (KR)

(72) Inventors: Gyeongcheol LEE, Seoul (KR); Seungjune YI, Seoul (KR); Sunyoung LEE, Seoul (KR); Geumsan JO, Seoul (KR)

(73) Assignee: LG ELECTRONICS INC., Seoul (KR)

(21) Appl. No.: 16/245,196

(22) Filed: Jan. 10, 2019

Related U.S. Application Data
(60) Provisional application No. 62/615,983, filed on Jan. 11, 2018.

(51) Int. Cl. H04W 28/02; H04W 24/10; H04W 72/14; H04W 72/12

(52) U.S. Cl. CPC H04W 28/0278; H04W 24/10; H04W 80/02; H04W 72/1247; H04W 72/14

(57) ABSTRACT

In the present invention, the method, communication device or processing device determines an amount of uplink (UL) data available for a logical channel group (LCG); and transmit the buffer status report including information on the amount of UL data available for the LCG. In the present invention, the amount of UL data available for the LCG is selected based on all logical channels of the LCG except for a logical channel related to a suspended radio link control (RLC) entity among RLC entities configured for the communication or processing device.

### CROSS-REFERENCE TO RELATED APPLICATIONS

Pursuant to 35 U.S.C. § 119(e), this application claims the benefit of U.S. Provisional Patent Application No. 62/615,983, filed on Jan. 11, 2018, the contents of which are hereby incorporated by reference herein in its entirety.

### TECHNICAL FIELD

The present disclosure relates to a wireless communication system.

### BACKGROUND ART

As an example of a mobile communication system to which the present disclosure is applicable, a 3rd Generation Partnership Project Long Term Evolution (hereinafter, referred to as LTE) communication system is described in brief.

FIG. 1 is a diagram illustrating an example of a network structure of an E-UMTS as an exemplary radio communication system. An Evolved Universal Mobile Telecommunications System (E-UMTS) is an advanced version of a Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

### SUMMARY

Introduction of new radio communication technologies has led to increases in the number of user equipments (UEs) to which a base station (BS) provides services in a prescribed resource region, and has also led to increases in the amount of data and control information that the BS transmits to the UEs. Due to typically limited resources available to the BS for communication with the UE(s), new techniques are needed by which the BS utilizes the limited radio resources to efficiently receive/transmit uplink/downlink data and/or uplink/downlink control information. In particular, overcoming delay or latency has become an important challenge in applications whose performance critically depends on delay/latency.

The technical objects that can be achieved through the present invention are not limited to what has been particularly described hereinabove and other technical objects not described herein will be more clearly understood by persons skilled in the art from the following detailed description.

In an aspect of the present disclosure, provided herein is a communication device for transmitting a buffer status report in a wireless communication system. The communication device comprises a transceiver, and a processor configured to control the transceiver. The processor is configured to: determine an amount of uplink (UL) data available for a logical channel group (LCG); and control the transceiver to transmit the buffer status report including information on the amount of UL data available for the LCG. The processor is configured to determine the amount of UL data available for the LCG based on all logical channels of the LCG except for a logical channel related to a suspended radio link control (RLC) entity among RLC entities configured for the communication device.

In another aspect of the present disclosure, provided herein is a processing device. The processing device comprises at least one processor; and at least one computer memory that is operably connectable to the at least one processor and that has stored thereon instructions which, when executed, cause the at least one processor to perform operations. The operations comprises: determining an amount of uplink (UL) data available for a logical channel group (LCG); and transmitting a buffer status report including information on the amount of UL data available for the LCG. The operations comprises determining the amount of UL data available for the LCG based on all logical channels of the LCG except for a logical channel related to a suspended radio link control (RLC) entity among RLC entities configured in the processing device

In a further aspect of the present disclosure, provided herein is a method for transmitting, by a communication device, a buffer status report in a wireless communication system. The method comprises: determining an amount of uplink (UL) data available for a logical channel group (LCG); and transmitting the buffer status report including information on the amount of UL data available for the LCG. The amount of UL data available for the LCG is determined based on all logical channels of the LCG except for a logical channel related to a suspended radio link control (RLC) entity among RLC entities configured for the communication device

In each aspect of the present disclosure, the logical channel related to the suspended RLC entity may comprise a logical channel related to a suspended radio bearer, a logical channel related to an RLC entity in which a maximum number of retransmissions has been reached, a logical channel related to an RLC entity perform RLC re-establishment, or a logical channel related to a packet data convergence protocol (PDCP) entity performing PDCP re-establishment.

In each aspect of the present disclosure, the communication device, the processing device or the method may further perform: receiving an UL grant may be received in response to the buffer status report; selecting logical channels related to the UL grant; allocating resources of the UL grant to the selected logical channels; and transmitting UL data of the selected logical channels based on the UL grant. The logical channels related to the UL grant may be selected from among logical channels not related to the suspended RLC entity.

In each aspect of the present disclosure, the resources of the UL grant may be allocated to the selected logical channels in a predefined order of priority.

In each aspect of the present disclosure, selecting the logical channels related to the UL grant and allocating the resources of the UL grant may be performed at a medium access control (MAC) entity.

The above technical solutions are merely some parts of the implementations of the present disclosure and various implementations into which the technical features of the present disclosure are incorporated can be derived and understood by persons skilled in the art from the following detailed description of the present disclosure.

In some scenarios, implementations of the present disclosure may provide one or more of the following advantages. In some scenarios, radio communication signals can be more efficiently transmitted and/or received. Therefore, overall throughput of a radio communication system can be improved.

According to some implementations of the present disclosure, delay/latency occurring during communication between a user equipment and a BS may be reduced.

Also, signals in a new radio access technology system can be transmitted and/or received more effectively.

It will be appreciated by persons skilled in the art that the effects that can be achieved through the present disclosure are not limited to what has been particularly described hereinabove and other advantages of the present disclosure will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention:

FIG. 1 is a diagram illustrating an example of a network structure of an evolved universal mobile telecommunication system (E-UMTS) as an exemplary radio communication system;

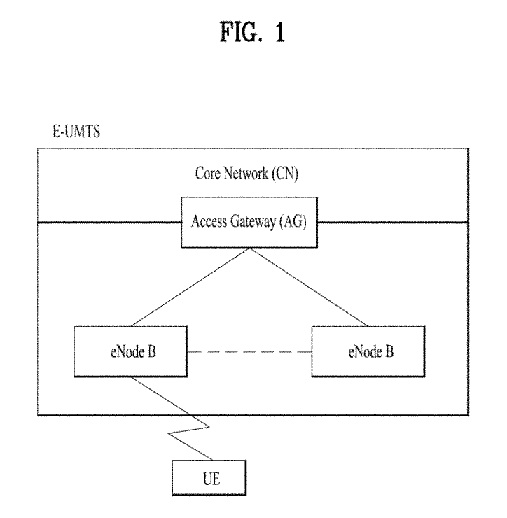

FIG. 2 is a block diagram illustrating an example of an evolved universal terrestrial radio access network (E-UTRAN);

FIG. 3 is a block diagram depicting an example of an architecture of a typical E-UTRAN and a typical EPC;

FIG. 4 illustrates an example of protocol stacks of the 3GPP based communication system;

FIG. 5 illustrates an example of a frame structure in the 3GPP based wireless communication system;

FIG. 6 illustrates an example of a data flow in the 3GPP NR system;

FIG. 7 illustrates a model of an acknowledged mode (AM) radio link control (RLC) entity which can be used in the implementation(s) of the present disclosure;

FIG. 8 illustrates an example of radio protocol architecture for packet duplication in the 3GPP based communication system;

FIG. 9 illustrates an implementation example of the present disclosure; and

FIG. 10 is a block diagram illustrating examples of communication devices which can perform method(s) of the present disclosure.

### DETAILED DESCRIPTION

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

Reference will now be made in detail to the exemplary implementations of the present disclosure, examples of which are illustrated in the accompanying drawings. The detailed description, which will be given below with reference to the accompanying drawings, is intended to explain exemplary implementations of the present disclosure, rather than to show the only implementations that can be implemented according to the disclosure. The following detailed description includes specific details in order to provide a thorough understanding of the present disclosure. However, it will be apparent to those skilled in the art that the present disclosure may be practiced without such specific details.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, implementations of the present disclosure are described in regards to a 3GPP based wireless communication system. However, the technical features of the present disclosure are not limited thereto. For example, although the following detailed description is given based on a mobile communication system corresponding to a 3GPP based system, aspects of the present disclosure that are not limited to 3GPP based system are applicable to other mobile communication systems.

For example, the present disclosure is applicable to contention based communication such as Wi-Fi as well as non-contention based communication as in the 3GPP based system in which a BS allocates a DL/UL time/frequency resource to a UE and the UE receives a DL signal and transmits a UL signal according to resource allocation of the BS. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

For terms and technologies which are not specifically described among the terms of and technologies employed in the present disclosure, the wireless communication standard documents published before the present disclosure may be referenced. For example, the following documents may be referenced.

3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

3GPP NR
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

In the present disclosure, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present disclosure, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the EPC/LTE is referred to as an eNB, and a BS of the new radio (NR) system is referred to as a gNB.

In the present disclosure, a node refers to a fixed point capable of transmitting/receiving a radio signal through communication with a UE. Various types of BSs may be used as nodes irrespective of the terms thereof. For example, a BS, a node B (NB), an enode B (eNB), a pico-cell eNB (PeNB), a home eNB (HeNB), a relay, a repeater, etc. may be a node. In addition, the node may not be a BS. For example, the node may be a radio remote head (RRH) or a radio remote unit (RRU). The RRH or RRU generally has a lower power level than a power level of a BS. Since the RRH or RRU (hereinafter, RRH/RRU) is generally connected to the BS through a dedicated line such as an optical cable, cooperative communication between RRH/RRU and the BS can be smoothly performed in comparison with cooperative communication between BSs connected by a radio line. At least one antenna is installed per node. The antenna may include a physical antenna or an antenna port or a virtual antenna.

In the present disclosure, the term “cell” may refer to a geographic area to which one or more nodes provide a communication system, or refer to radio resources. A “cell” of a geographic area may be understood as coverage within which a node can provide service using a carrier and a “cell” as radio resources (e.g. time-frequency resources) is associated with bandwidth (BW) which is a frequency range configured by the carrier. The “cell” associated with the radio resources is defined by a combination of downlink resources and uplink resources, for example, a combination of a downlink (DL) component carrier (CC) and a uplink (UL) CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In carrier aggregation (CA), two or more CCs are aggregated. A UE may simultaneously receive or transmit on one or multiple CCs depending on its capabilities. CA is supported for both contiguous and non-contiguous CCs. When CA is configured the UE only has one radio resource control (RRC) connection with the network. At RRC connection establishment/re-establishment/handover, one serving cell provides the non-access stratum (NAS) mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell. The configured set of serving cells for a UE therefore always consists of one PCell and one or more SCells. For dual connectivity operation, the term Special Cell (SpCell) refers to the PCell of the master cell group (MCG) or the PSCell of the secondary cell group (SCG). An SpCell supports PUCCH transmission and contention-based random access, and is always activated. The MCG is a group of serving cells associated with a master node, comprising of the SpCell (PCell) and optionally one or more SCells. The SCG is the subset of serving cells associated with a secondary node, comprising of the PSCell and zero or more SCells, for a UE configured with dual connectivity (DC). For a UE in RRC_CONNECTED not configured with CA/DC there is only one serving cell comprising of the PCell. For a UE in RRC_CONNECTED configured with CA/DC the term “serving cells” is used to denote the set of cells comprising of the SpCell(s) and all SCells. In DC, two MAC entities are configured in a UE: one for the MCG and one for the SCG.

In the present disclosure, “PDCCH” may refer to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present disclosure, monitoring a channel refers to attempting to decode the channel. For example, monitoring a PDCCH refers to attempting to decode PDCCH(s) (or PDCCH candidates).

In the present disclosure, for dual connectivity (DC) operation, the term “special Cell” refers to the PCell of the master cell group (MCG) or the PSCell of the secondary cell group (SCG), and otherwise the term Special Cell refers to the PCell. The MCG is a group of serving cells associated with a master BS which terminates at least S1-MME, and the SCG is a group of serving cells associated with a secondary BS that is providing additional radio resources for the UE but is not the master BS. The SCG includes a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present disclosure, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI”, “SL-RNTI” refers to a sidelink RNTI, “SPS C-RNTI” refers to a semi-persistent scheduling C-RNTI, and “CS-RNTI” refers to a configured scheduling RNTI.

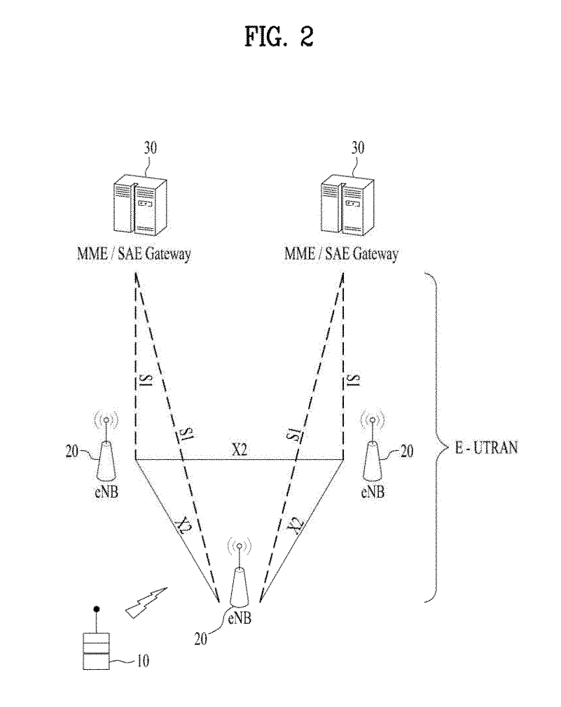

FIG. 2 is a block diagram illustrating an example of an evolved universal terrestrial radio access network (E-UTRAN). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipments (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from BS 20 to UE 10, and “uplink” refers to communication from the UE to a BS.

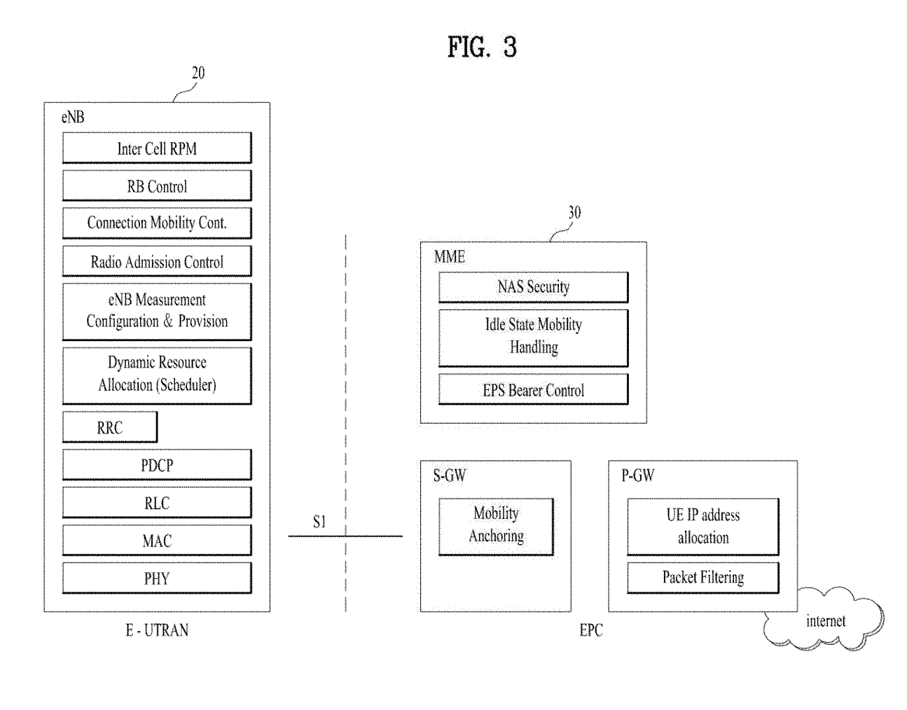

FIG. 3 is a block diagram depicting an example of an architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, access stratum (AS) Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Building upon its success of IMT-2000 (3G) and IMT-Advanced (4G), 3GPP has been devoting its effort to IMT-2020 (5G) development since September 2015. 5G New Radio (NR) is expected to expand and support diverse use case scenarios and applications that will continue beyond the current IMT-Advanced standard, for instance, enhanced Mobile Broadband (eMBB), Ultra Reliable Low Latency Communication (URLLC) and massive Machine Type Communication (mMTC). eMBB is targeting high data rate mobile broadband services, such as seamless data access both indoors and outdoors, and augmented reality (AR)/virtual reality (VR) applications; URLLC is defined for applications that have stringent latency and reliability requirements, such as vehicular communications that can enable autonomous driving and control network in industrial plants; mMTC is the basis for connectivity in IoT, which allows for infrastructure management, environmental monitoring, and healthcare applications.

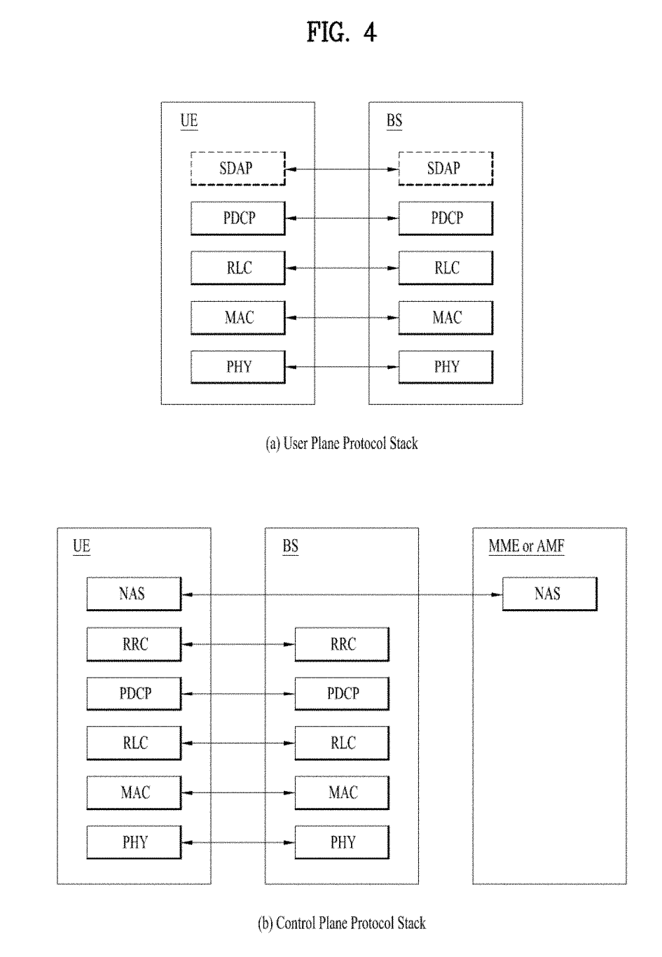

FIG. 4 illustrates an example of protocol stacks in a 3GPP based wireless communication system.

In particular, FIG. 4(a) illustrates an example of a radio interface user plane protocol stack between a UE and a base station (BS) and FIG. 4(b) illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4(a), the user plane protocol stack may be divided into a first layer (Layer 1) (i.e., a physical (PHY) layer) and a second layer (Layer 2). Referring to FIG. 4(b), the control plane protocol stack may be divided into Layer 1 (i.e., a PHY layer), Layer 2, Layer 3 (e.g., a radio resource control (RRC) layer), and a non-access stratum (NAS) layer. Layer 1, Layer 2 and Layer 3 are referred to as an access stratum (AS).

In the 3GPP LTE system, the layer 2 is split into the following sublayers: Medium Access Control (MAC), Radio Link Control (RLC), and Packet Data Convergence Protocol (PDCP). In the 3GPP New Radio (NR) system, the layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G Core Network QoS flows.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of Signalling Radio Bearers (SRBs) and Data Radio Bearers (DRBs); mobility functions (including: handover and context transfer; UE cell selection and reselection and control of cell selection and reselection; Inter-RAT mobility); QoS management functions; UE measurement reporting and control of the reporting; detection of and recovery from radio link failure; NAS message transfer to/from NAS from/to UE.

In the 3GPP NR system, the main services and functions of the PDCP sublayer for the user plane include: sequence numbering; header compression and decompression: ROHC only; transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the RLC sublayer supports three transmission modes: Transparent Mode (TM); Unacknowledged Mode (UM); and Acknowledged Mode (AM). The RLC configuration is per logical channel with no dependency on numerologies and/or transmission durations. In the 3GPP NR system, the main services and functions of the RLC sublayer depend on the transmission mode and include: Transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use. Different kinds of data transfer services are offered by MAC. To accommodate different kinds of data transfer services, multiple types of logical channels are defined i.e. each supporting transfer of a particular type of information. Each logical channel type is defined by what type of information is transferred. Logical channels are classified into two groups: Control Channels and Traffic Channels. Control channels are used for the transfer of control plane information only, and traffic channels are used for the transfer of user plane information only. Broadcast Control Channel (BCCH) is a downlink logical channel for broadcasting system control information, paging Control Channel (PCCH) is a downlink logical channel that transfers paging information, system information change notifications and indications of ongoing PWS broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In Downlink, the following connections between logical channels and transport channels exist: BCCH can be mapped to BCH; BCCH can be mapped to downlink shared channel (DL-SCH); PCCH can be mapped to PCH; CCCH can be mapped to DL-SCH; DCCH can be mapped to DL-SCH; and DTCH can be mapped to DL-SCH. In Uplink, the following connections between logical channels and transport channels exist: CCCH can be mapped to uplink shared channel (UL-SCH); DCCH can be mapped to UL-SCH; and DTCH can be mapped to UL-SCH.

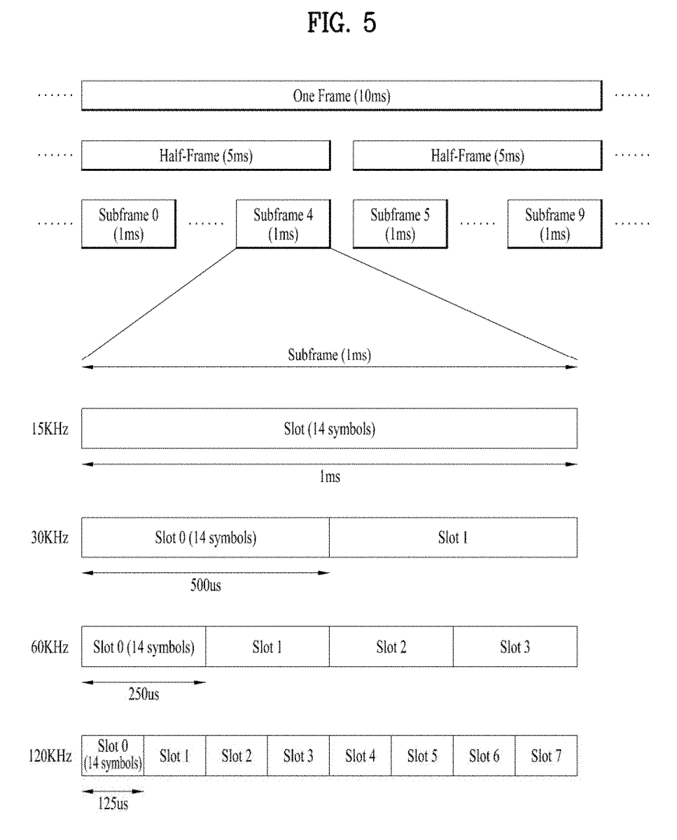

FIG. 5 illustrates an example of a frame structure in the 3GPP based wireless communication system.

The frame structure illustrated in FIG. 5 is purely exemplary and the number of subframes, the number of slots, and/or the number of symbols in a frame may be variously changed. In the 3GPP based wireless communication system, an OFDM numerology (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g. a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 5, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz. The following table shows the number of OFDM symbols per slot, the number of slots per frame, and the number of slots per for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The following table shows the number of OFDM symbols per slot, the number of slots per frame, and the number of slots per for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g. subcarrier spacing) and carrier, a resource grid of N^{size,u}_{grid,x N}^{RB}_{sc} subcarriers and N^{subframe,u}_{symb} OFDM symbols is defined, starting at common resource block (CRB) N^{start,u}_{grid} indicated by higher-layer signaling (e.g. radio resource control (RRC) signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

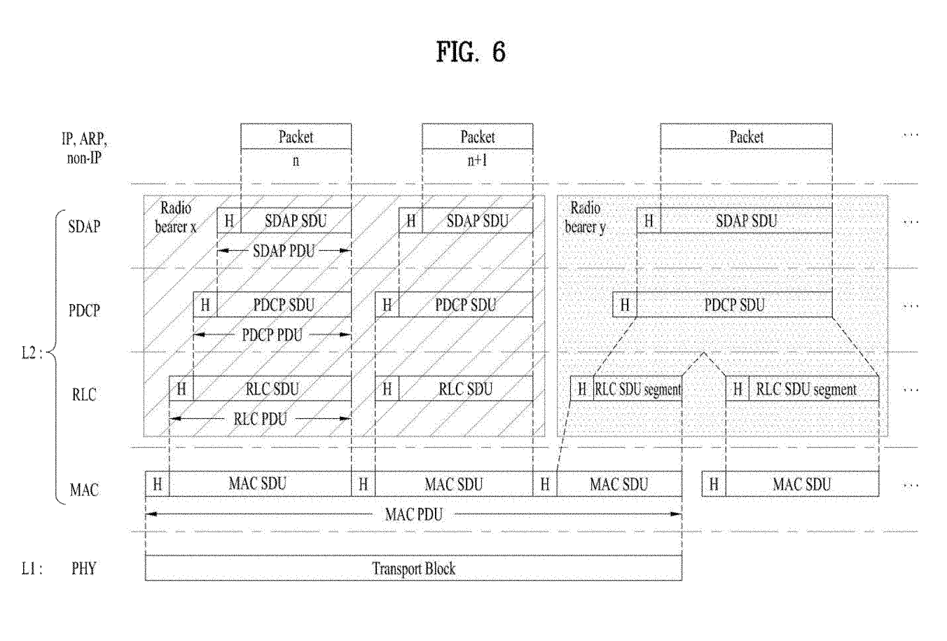

FIG. 6 illustrates an example of a data flow in the 3GPP NR system. In FIG. 6, “H” denotes headers and subheaders.

The MAC PDU is transmitted/received using radio resources through the PHY layer to/from an external device. The MAC PDU arrives to the PHY layer in the form of a transport block. In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Functions of the PDCP sublayer are performed by PDCP entities. Several PDCP entities may be defined for a UE. Each PDCP entity is carrying the data of one radio bearer. A PDCP entity is associated either to the control plane or the user plane depending on which radio bearer it is carrying data for. Each RB (except for SRBO) is associated with one PDCP entity. Each PDCP entity is associated with one, two, or four RLC entities depending on the RB characteristic (e.g. uni-directional/bi-directional or split/non-split) or RLC mode. For non-split bearers, each PDCP entity is associated with one UM RLC entity, two UM RLC entities (one for each direction), or one AM RLC entity. For split bearers, each PDCP entity is associated with two UM RLC entities (for same direction), four UM RLC entities (two for each direction), or two AM RLC entities (for same direction).

When upper layers (e.g. RRC) request a PDCP entity establishment for a radio bearer, the UE establishes a PDCP entity for the radio bearer; sets state variables of the PDCP entity to initial values; and follows the data transfer procedure.

When upper layers (e.g. RRC) request a PDCP entity re-establishment, the transmitting PDCP entity: for UM DRBs and AM DRBs, resets the header compression protocol for uplink and start with an IR state in U-mode if drb-ContinueROHC is not configured in RRC; for UM DRBs and SRBs, sets TX_NEXT to the initial value; for SRBs, discard all stored PDCP SDUs and PDCP PDUs; applies the ciphering algorithm and key provided by upper layers during the PDCP entity re-establishment procedure; applies the integrity protection algorithm and key provided by upper layers during the PDCP entity re-establishment procedure; for UM DRBs, for each PDCP SDU already associated with a PDCP SN but for which a corresponding PDU has not previously been submitted to lower layers, considers the PDCP SDUs as received from upper layer and performs transmission of the PDCP SDUs in ascending order of the COUNT value associated to the PDCP SDU prior to the PDCP re-establishment without restarting the discardTimer; for AM DRBs, from the first PDCP SDU for which the successful delivery of the corresponding PDCP Data PDU has not been confirmed by lower layers, performs retransmission or transmission of all the PDCP SDUs already associated with PDCP SNs in ascending order of the COUNT values associated to the PDCP SDU prior to the PDCP entity re-establishment. After performing the PDCP entity re-establishment, the UE follows the data transfer procedure.

Functions of the RLC sublayer are performed by RLC entities. For an RLC entity configured at a BS, there is a peer RLC entity configured at the UE and vice versa. When upper layers (e.g. RRC) request an RLC entity establishment, the UE establishes an RLC entity, sets the state variable of the RLC entity to initial values, and follows the data transfer procedure. When upper layers (e.g. RRC) request an RLC entity re-establishment, the UE discards all RLC SDUs, RLC SDU segments, and RLC PDUs, if any; stops and resets all timers; and resets all state variables to their initial values. When upper layers (e.g. RRC) request an RLC entity release, the UE discards all RLC SDUs, RLC SDU segments, and RLC PDUs, if any; and releases the RLC entity.

An RLC entity receives/delivers RLC SDUs from/to upper layer and sends/receives RLC PDUs to/from its peer RLC entity via lower layers. An RLC entity can be configured to perform data transfer in one of the following three modes: Transparent Mode (TM), Unacknowledged Mode (UM) or Acknowledged Mode (AM). Consequently, an RLC entity is categorized as a TM RLC entity, an UM RLC entity or an AM RLC entity depending on the mode of data transfer that the RLC entity is configured to provide. A TM RLC entity is configured either as a transmitting TM RLC entity or a receiving TM RLC entity. The transmitting TM RLC entity receives RLC SDUs from upper layer and sends RLC PDUs to its peer receiving TM RLC entity via lower layers. The receiving TM RLC entity delivers RLC SDUs to upper layer and receives RLC PDUs from its peer transmitting TM RLC entity via lower layers. An UM RLC entity is configured either as a transmitting UM RLC entity or a receiving UM RLC entity. The transmitting UM RLC entity receives RLC SDUs from upper layer and sends RLC PDUs to its peer receiving UM RLC entity via lower layers. The receiving UM RLC entity delivers RLC SDUs to upper layer and receives RLC PDUs from its peer transmitting UM RLC entity via lower layers. An AM RLC entity consists of a transmitting side and a receiving side. The transmitting side of an AM RLC entity receives RLC SDUs from upper layer and sends RLC PDUs to its peer AM RLC entity via lower layers. The receiving side of an AM RLC entity delivers RLC SDUs to upper layer and receives RLC PDUs from its peer AM RLC entity via lower layers.

In the implementations of the present disclosure, the following services are expected by RLC from lower layer (i.e. MAC): data transfer; and notification of a transmission opportunity together with the total size of the RLC PDU(s) to be transmitted in the transmission opportunity.

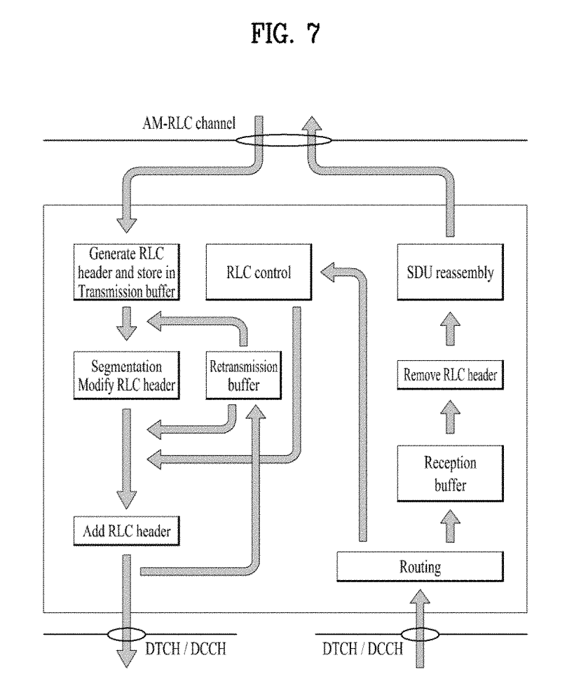

FIG. 7 illustrates a model of an acknowledged mode (AM) radio link control (RLC) entity which can be used in the implementation(s) of the present disclosure.

In the 3GPP NR system, RLC SDUs of variable sizes which are byte aligned (i.e. multiple of 8 bits) are supported for all RLC entity type (TM, UM and AM RLC entity), which is similar in the 3GPP LTE system. In the 3GPP LTE system, however, each RLC SDU is used to construct an RLC PDU without waiting for notification from the lower layer (i.e., by MAC) of a transmission opportunity. In the case of UM and AM RLC entities, an RLC SDU may be segmented and transported using two or more RLC PDUs based on the notification(s) from the lower layer. RLC PDUs are submitted to lower layer only when a transmission opportunity has been notified by lower layer (i.e. by MAC). In other words, in the 3GPP NR system, the RLC entity is allowed to construct RLC data PDUs in advance even without notification of a transmission opportunity by the lower layer, i.e., pre-construction of RLC data PDU is allowed. When and how many RLC data PDUs are pre-constructed is left up to UE implementation.

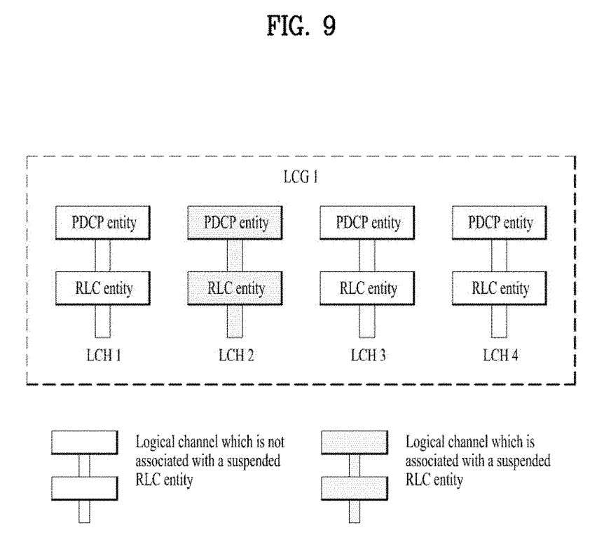

Referring to FIG. 9, an AM RLC entity can be configured to deliver/receive RLC PDUs through the following logical channels: DL/UL DCCH or DL/UL DTCH. An AM RLC entity delivers/receives the following RLC data PDUs: AMD PDU. An AMD PDU contains either one complete RLC SDU or one RLC SDU segment. An AM RLC entity delivers/receives a STATUS PDU which is an RLC control PDU.

In the implementation(s) of the present disclosure, the transmitting side of an AM RLC entity generates AMD PDU(s) for each RLC SDU. When notified of a transmission opportunity by the lower layer, the transmitting AM RLC entity segments the RLC SDUs, if needed, so that the corresponding AMD PDUs, with RLC headers updated as needed, fit within the total size of RLC PDU(s) indicated by lower layer.

The transmitting side of an AM RLC entity supports retransmission of RLC SDUs or RLC SDU segments (ARQ):
if the RLC SDU or RLC SDU segment to be retransmitted (including the RLC header) does not fit within the total size of RLC PDU(s) indicated by lower layer at the particular transmission opportunity notified by lower layer, the AM RLC entity can segment the RLC SDU or re-segment the RLC SDU segments into RLC SDU segments,
the number of re-segmentation is not limited.

When the transmitting side of an AM RLC entity forms AMD PDUs from RLC SDUs or RLC SDU segments, it includes relevant RLC headers in the AMD PDU.

In the implementation(s) of the present disclosure, an AMD PDU consists of a Data field and an AMD PDU header. An AM RLC entity may configured by RRC to use either a 12 bit SN or a 18 bit SN. An AMD PDU header contains a P field and a SN.

An AMD PDU consists of a Data field and an AMD PDU header. The P field is included in the AMD PDU header, and indicates whether or not the transmitting side of an LTE AM RLC entity requests a STATUS report from its peer LTE AM RLC entity. The interpretation of the P field is provided in the following table

TABLE 3

| Value | Description |
|---|---|
| 0 | Status report not requested |
| 1 | Status report is requested |

In the implementation(s) of the present disclosure, data transfer procedures between the transmitting side of an RLC entity and the receiving side of an RLC entity are as follows.

The transmitting side of an AM RLC entity prioritizes transmission of RLC control PDUs over AMD PDUs. The transmitting side of an AM RLC entity prioritizes transmission of AMD PDUs containing previously transmitted RLC SDUs or RLC SDU segments over transmission of AMD PDUs containing not previously transmitted RLC SDUs or RLC SDU segments.

The transmitting side of an AM RLC entity maintains a transmitting window according to the state variable TX_Next_Ack as follows:
a SN falls within the transmitting window if TX_Next_Ack<=SN<TX_Next_Ack+AM_Window_Size;
a SN falls outside of the transmitting window otherwise. TX_Next_Ack is the acknowledgement state variable maintained in the transmitting side of each AM RLC entity, and holds the value of the SN of the next RLC SDU for which a positive acknowledgment is to be received in-sequence, and it serves as the lower edge of the transmitting window. It is initially set to 0, and is updated whenever the AM RLC entity receives a positive acknowledgment for an RLC SDU with SN=TX_Next_Ack. AM_Window_Size is a constant used by both the transmitting side and the receiving side of each AM RLC entity. AM_Window_Size=2048 when a 12 bit SN is used, AM_Window_Size=131072 when an 18 bit SN is used.

The transmitting side of an AM RLC entity does not submit to lower layer (i.e. MAC) any AMD PDU whose SN falls outside of the transmitting window. In other words, any AMD PDU whose SN falls outside of the transmitting window is not transmitted in a corresponding transmission opportunity.

For each RLC SDU received from the upper layer (e.g. PDCP), the AM RLC entity associates a SN with the RLC SDU equal to TX_Next and constructs an AMD PDU by setting the SN of the AMD PDU to TX_Next, and increments TX_Next by one. TX_Next is a state variable maintained in the transmitting side of each AM RLC entity and holds the value of the SN to be assigned for the next newly generated AMD PDU. TX_Next is initially set to 0, and is updated whenever the AM RLC entity constructs an AMD PDU with SN=TX_Next which contains an RLC SDU or the last segment of an RLC SDU.

When submitting an AMD PDU that contains a segment of an RLC SDU, to lower layer, the transmitting side of an AM RLC entity sets the SN of the AMD PDU to the SN of the corresponding RLC SDU.

The transmitting side of an AM RLC entity can receive a positive acknowledgement (confirmation of successful reception by its peer AM RLC entity) for an RLC SDU by a STATUS PDU from its peer AM RLC entity.

When receiving a positive acknowledgement for an RLC SDU with SN=x, the transmitting side of an AM RLC entity sends an indication to the upper layers of successful delivery of the RLC SDU; and sets TX_Next_Ack equal to the SN of the RLC SDU with the smallest SN, whose SN falls within the range TX_Next_Ack<=SN<=TX_Next and for which a positive acknowledgments has not been received yet.

The transmitting side of an AM RLC entity can receive a negative acknowledgement (notification of reception failure by its peer AM RLC entity) for an RLC SDU or an RLC SDU segment by a STATUS PDU from its peer AM RLC entity.

When receiving a negative acknowledgement for an RLC SDU or an RLC SDU segment by a STATUS PDU from its peer AM RLC entity, the transmitting side of the AM RLC entity may consider the RLC SDU or the RLC SDU segment, for which a negative acknowledgement was received, for retransmission if the SN of the corresponding RLC SDU falls within the range TX_Next_Ack<=SN<TX_Next.

When an RLC SDU or an RLC SDU segment is considered for retransmission, the transmitting side of the AM RLC entity:
sets the RETX_COUNT associated with the RLC SDU to zero if the RLC SDU or RLC SDU segment is considered for retransmission for the first time;
increments the RETX_COUNT if it (the RLC SDU or the RLC SDU segment that is considered for retransmission) is not pending for retransmission already and the RETX_COUNT associated with the RLC SDU has not been incremented due to another negative acknowledgment in the same STATUS PDU;
indicate to upper layers (e.g. RRC) that the maximum number of retransmissions has been reached if RETX_COUNT=maxRetxThreshold. RETX_COUNT is a counter maintained in the transmitting side of each AM RLC entity and counts the number of retransmissions of an RLC SDU or RLC SDU segment. There is one RETX_COUNT counter maintained per RLC SDU. maxRetxThreshold is a parameter configured by RRC, and used by the transmitting side of each AM RLC entity to limit the number of retransmissions corresponding to an RLC SDU, including its segments. If the transmitting side of an AM RLC entity is a UE, the UE is configured with maxRetxThreshold by receiving maxRetxThreshold via RRC signaling from a network (e.g. BS).

When retransmitting an RLC SDU or an RLC SDU segment, the transmitting side of an AM RLC entity:
segments the RLC SDU or the RLC SDU segment if needed;
forms a new AMD PDU which will fit within the total size of AMD PDU(s) indicated by lower layer at the particular transmission opportunity; and
submits the new AMD PDU to lower layer.

When forming a new AMD PDU, the transmitting side of an AM RLC entity:
maps only the original RLC SDU or RLC SDU segment to the Data field of the new AMD PDU; and
modifies the header of the new AMD PDU.

An AM RLC entity can poll its peer AM RLC entity in order to trigger STATUS reporting at the peer AM RLC entity. The transmitting side of an AM RLC entity can poll its peer AM RLC entity by submitting an RLC data PDU including a poll to MAC layer for transmission. In the present disclosure, an RLC data PDU including a poll means an RLC data PDU with the poll bit set to “1”. In other words, in the present disclosure, including a poll in an RLC PDU refers to including the value “1” in the P field included in the RLC PDU, and an RLC PDU including a poll means an RLC PDU whose P field includes the value “1”.

When an AMD PDU is received from lower layer (MAC), where the AMD PDU contains byte segment numbers y to z of an RLC SDU with SN=x, the receiving side of an AM RLC entity:
if x falls outside of the receiving window; or
if byte segment numbers y to z of the RLC SDU with SN=x have been received before:
   discard the received AMD PDU.
else:
   place the received AMD PDU in the reception buffer;
   if some byte segments of the RLC SDU contained in the AMD PDU have been received before:
      discard the duplicate byte segments.

An AM RLC entity sends STATUS PDUs to its peer AM RLC entity in order to provide positive and/or negative acknowledgements of RLC SDUs (or portions of them). Triggers to initiate STATUS reporting include:
Polling from its peer AM RLC entity:
When an AMD PDU with SN=x and the P field set to “1” is received from lower layer (MAC), the receiving side of an AM RLC entity:
   if the AMD PDU is to be discarded as described above; or
   if x<RX_Highest_Status or x>=RX_Next+AM_Window_Size:
      trigger a STATUS report.
   else:
      delay triggering the STATUS report until x<RX_Highest_Status or x>=RX_Next+AM_Window_Size.
Detection of reception failure of an AMD PDU:
   The receiving side of an AM RLC entity shall trigger a STATUS report when t-Reassembly expires.

The receiving side of each AM RLC entity maintains state variables RX_Highest_Status and RX_Next. RX_Highest_Status is the maximum STATUS transmit state variable which holds the highest possible value of the SN which can be indicated by “ACK_SN” when a STATUS PDU needs to be constructed. RX_Highest_Status is initially set to 0. RX_Next is the receive state variable which holds the value of the SN following the last in-sequence completely received RLC SDU, and it serves as the lower edge of the receiving window. RX_Next is initially set to 0, and is updated whenever the AM RLC entity receives an RLC SDU with SN=RX_Next.

The expiry of t-Reassembly triggers both RX_Highest_Status to be updated and a STATUS report to be triggered, but the STATUS report shall be triggered after RX_Highest_Status is updated. t-Reassembly is a timer configured by RRC, and used by the receiving side of an AM RLC entity and receiving UM RLC entity in order to detect loss of RLC PDUs at lower layer. If t-Reassembly is running, t-Reassembly is not started additionally, i.e. only one t-Reassembly per RLC entity is running at a given time.

When STATUS reporting has been triggered, the receiving side of an AM RLC entity:
if t-StatusProhibit is not running:
   at the first transmission opportunity indicated by lower layer, constructs a STATUS PDU and submit it to lower layer.
else:
   at the first transmission opportunity indicated by lower layer after t-StatusProhibit expires, constructs a single STATUS PDU even if status reporting was triggered several times while t-StatusProhibit was running and submit it to lower layer.

t-StatusProhibit is a timer configured by RRC, and used by the receiving side of an AM RLC entity in order to prohibit transmission of a STATUS PDU. When a STATUS PDU has been submitted to lower layer, the receiving side of an AM RLC entity starts t-StatusProhibit.

In addition, if a STATUS PDU has been triggered and t-StatusProhibit is not running or has expired, the UE shall estimate the size of the STATUS PDU that will be transmitted in the next transmission opportunity, and consider this as part of RLC data volume.

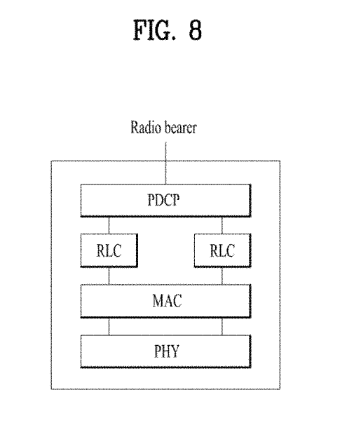

FIG. 8 illustrates an example of radio protocol architecture for packet duplication in the 3GPP based communication system.

In carrier aggregation (CA) of the legacy 3GPP LTE system, when the transmitting side of an AM RLC entity reaches the maximum number of retransmission, the transmitting side of an AM RLC entity indicates to upper layers (RRC) that the maximum number of retransmissions has been reached and then the RRC layer performs RRC re-establishment procedure. All RLC entities would be re-established by RRC re-establishment procedure.

In the 3GPP based communication system, PDCP packet duplication is newly introduced and can be configured with CA. Hereinafter, this is called CA duplication. When duplication is configured for a radio bearer by RRC, at least one secondary RLC entity and at least one secondary logical channel are added to the radio bearer to handle the duplicated PDCP PDUs. Referring to FIG. 8, duplication at PDCP therefore consists in submitting the same PDCP PDUs twice: once to the primary RLC entity and a second time to the secondary RLC entity. With two independent transmission paths, packet duplication therefore increases reliability and reduces latency and is especially beneficial for ultra-reliable low-latency communication (URLLC) services. When duplication is activated, the original PDCP PDU and the corresponding duplicate shall not be transmitted on the same carrier. In CA duplication, the two different logical channels can either belong to the same MAC entity (CA).

For the 3GPP based communication, it has been recently agreed that, in CA duplication, when the transmitting side of an AM RLC entity, which is configured on an SCell, reaches the maximum number of retransmission, the RRC does not perform RRC connection re-establishment and reports the failure to the BS. As RRC does not perform RRC re-establishment, MAC is not reset. This situation is different from a radio bearer suspension at RRC connection re-establishment procedure, where the MAC entity is reset.

In this condition, even though the transmitting side of an AM RLC entity reaches the maximum number of retransmissions, all remaining RLC entities except for the RLC entity reaching maximum number of retransmissions can keep submitting RLC PDUs to lower layer (i.e., MAC) upon receiving notification of a transmission opportunity by lower layer. In other words, only the RLC entity reaching the maximum number of retransmissions, which is configured on an SCell, is suspended and cannot transmit a data until RLC re-establishment is performed.

However, the transmitting side of an AM RLC entity indicates to upper layers only that the maximum number of retransmissions has been reached. Therefore, the MAC entity does not know whether an RLC entity is suspended or not. As the MAC entity is not reset, it performs normal operation related to transmission.

The MAC entity supports functions related to transmission. The MAC functions related to transmission comprise priority handling between logical channels of one UE by means of logical channel prioritization (LCP), and scheduling information reporting such as buffer status reporting. If the MAC entity does not know whether an RLC entity is suspended or not, the MAC entity would include the logical channel, which is associated with a suspended RLC entity, into LCP procedure for an UL grant. Eventually even if the suspended RLC entity cannot transmit data, the MAC entity would give an unnecessary transmission opportunity to the suspended RLC entity after LCP. Another problem can occur in the buffer status report (BSR) procedure. Actually the suspended RLC entity should not be included into data volume calculation because available data into the suspended RLC entity cannot be transmitted. This means that if the logical channel associated with the suspended RLC entity is included into the BSR procedure, MAC may report very large buffer status to the BS unnecessarily. This is serious problem and can deteriorate performance of the whole system.

Therefore, a new indication informing a lower layer (i.e. MAC) that the maximum number of retransmissions has been reached should be introduced, and the MAC entity should apply the indication to the MAC procedure to resolve these problems.

In the implementations of the present disclosure, when a MAC entity performs a MAC procedure for transmission, the MAC entity handles all logical channels except for a logical channel associated with a suspended RLC entity during the MAC procedure.

The implementations of the present disclosure can be applied to any type of UE, e.g., machine type communication (MTC) UE, narrowband internet of things (NB-IoT) UE, normal UE.

In the implementations of the present disclosure, a logical channel associated with a suspended RLC entity can be indicated by upper layers (i.e., RLC, PDCP, or RRC).

In the present disclosure, a logical channel associated with a suspended RLC entity may mean:
a logical channel associated with a suspended radio bearer (RB),
a logical channel associated with an RLC entity in which the maximum number of retransmissions has been reached,
a logical channel associated with an RLC entity performing RLC re-establishment, and/or
a logical channel associated with a PDCP entity performing PDCP re-establishment.

The suspended radio bearer may mean a radio bearer which cannot transport uplink data while other radio bearers can transport uplink data. If an RRC connection is suspended, all RBs are suspended. Unlike the normal RRC connection suspension, in the implementations of the present disclosure, only a specific RB may be suspended while transmission/reception on the other RBs is performed normally.

In other words, in the present disclosure, a suspended RLC entity may mean:
an RLC entity associated with a suspended radio bearer (RB),
an RLC entity in which the maximum number of retransmissions has been reached,
an RLC entity performing RLC re-establishment, and/or
an RLC entity associated with a PDCP entity performing PDCP re-establishment.

In the present disclosure, the MAC procedure for transmission includes logical channel prioritization (LCP) and/or buffer status reporting.

In the implementations of the present disclosure, an uplink grant is dynamically allocated via grant is either received dynamically on the PDCCH, in a Random Access Response, or configured semi-persistently by RRC. A UE monitors the PDCCH(s) in order to find possible grants for uplink transmission when its downlink reception is enabled (activity governed by discontinuous reception (DRX) when configured). In addition, with Configured Grants, the BS can allocate uplink resources for the initial HARQ transmissions to UEs. Two types of configured uplink grants are defined: Type 1 and Type 2. With Configured Grant Type 1, RRC directly provides the configured uplink grant (including the periodicity). For example, a UE is provided with at least information on time domain resource, information on frequency domain resource, and modulation coding scheme index, via RRC signaling from a BS when the configured grant type 1 is configured. With Configured Grant Type 2, RRC defines the periodicity of the configured uplink grant while PDCCH addressed to Configured Scheduling RNTI (CS-RNTI) can either signal and activate the configured uplink grant, or deactivate it; i.e. a PDCCH addressed to CS-RNTI indicates that the uplink grant can be implicitly reused according to the periodicity defined by RRC, until deactivated.

When the MAC entity receives indication of a logical channel associated with a suspended RLC entity from upper layers, the MAC entity considers the indicated logical channel is associated with a suspended RLC entity during the MAC procedure for transmission as described below.

The MAC multiplexes MAC control elements (CEs) and MAC SDUs in a MAC PDU based on the Logical Channel Prioritization procedure. In the present disclosure, the Logical Channel Prioritization procedure is applied whenever a new transmission is performed. RRC (of the BS) controls the scheduling of uplink data by signalling for each logical channel per MAC entity to a UE:
priority where an increasing priority value indicates a lower priority level;
prioritisedBitRate which sets the Prioritized Bit Rate (PBR);
bucketSizeDuration which sets the Bucket Size Duration (BSD).

RRC (of the BS) additionally controls the LCP procedure by configuring mapping restrictions for each logical channel by signalling the following mapping restrictions to a UE:
lcp-allowedSCS which sets the allowed Subcarrier Spacing(s) for transmission;
lcp-maxPUSCH-Duration which sets the maximum PUSCH duration allowed for transmission;
lcp-configuredGrantTypelAllowed which sets whether a Configured Grant Type 1 can be used for transmission;
lcp-allowedServingCells which sets the allowed cell(s) for transmission.

The MAC entity maintains a variable Bj for each logical channel j. Bj is initialized to zero when the related logical channel is established, and incremented before every instance of the LCP procedure by the product PBR*T, where PBR is Prioritized Bit Rate of logical channel j and T is the time elapsed since Bj was last updated. The exact moment(s) when the UE updates Bj between LCP procedures is up to UE implementation, as long as Bj is up to date at the time when a grant is processed by LCP. However, the value of Bj can never exceed the bucket size and if the value of Bj is larger than the bucket size of logical channel j, it shall be set to the bucket size. The bucket size of a logical channel is equal to PBR*BSD.

If the MAC entity is requested to simultaneously transmit multiple MAC PDUs, or if the MAC entity receives the multiple UL grants within one or more coinciding PDCCH occasions (i.e. on different serving cells), it is up to UE implementation in which order the grants are processed.

*Selection of Logical Channels

In an implementation of the present disclosure, the MAC entity may exclude a logical channel associated with a suspended RLC entity when selecting logical channel(s) for a UL grant. For example, when a new transmission is performed, the MAC entity may select logical channels for each UL grant that satisfy all the following conditions:
the set of allowed Subcarrier Spacing index values in lcp-allowedSCS, if configured, includes the Subcarrier Spacing index associated to the UL grant; and
lcp-maxPUSCH-Duration, if configured, is larger than or equal to the PUSCH transmission duration associated to the UL grant; and
lcp-configuredGrantTypelAllowed, if configured, is set to TRUE in case the UL grant is a Configured Grant Type 1; and
lcp-allowedServingCells, if configured, includes the Cell information associated to the UL grant; and
a logical channel is not associated with a suspended RLC entity.

The Subcarrier Spacing index, PUSCH transmission duration and Cell information are included in Uplink transmission information received from lower layers for the corresponding scheduled uplink transmission.

*Allocation of Resources

When a new transmission is performed, the MAC entity allocates resources to the logical channels as follows:
logical channels selected for the UL grant with Bj>0 are allocated resources in a decreasing priority order. If the PBR of a logical channel is set to “infinity”, the MAC entity shall allocate resources for all the data that is available for transmission on the logical channel before meeting the PBR of the lower priority logical channel(s);
decrement Bj by the total size of MAC SDUs served to logical channel j above, the value of Bj can be negative;
if any resources remain, all the logical channels selected through Section of logical channel are served in a strict decreasing priority order (regardless of the value of Bj) until either the data for that logical channel or the UL grant is exhausted, whichever comes first. Logical channels configured with equal priority should be served equally.

The UE also follows the rules below during the scheduling procedures above:
the UE should not segment an RLC SDU (or partially transmitted SDU or retransmitted RLC PDU) if the whole SDU (or partially transmitted SDU or retransmitted RLC PDU) fits into the remaining resources of the associated MAC entity;
if the UE segments an RLC SDU from the logical channel, it shall maximize the size of the segment to fill the grant of the associated MAC entity as much as possible;
the UE should maximise the transmission of data;
if the MAC entity is given an UL grant size that is equal to or larger than 8 bytes while having data available for transmission, the MAC entity shall not transmit only padding BSR and/or padding.

The MAC entity does not generate a MAC PDU for the hybrid automatic repeat request (HARQ) entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
the MAC PDU includes zero MAC SDUs; and
the MAC PDU includes only the periodic BSR and there is no data available for any logical channel group (LCG), or the MAC PDU includes only the padding BSR.

RRC (of the BS) can configure the MAC entity with skipUplinkTxDynamic by signalling skipUplinkTxDynami to the UE. If skipUplinkTxDynami is set to true, the UE skips UL transmissions for an uplink grant other than a configured grant if no data is available for transmission in the UE buffer.

Logical channels are prioritised in accordance with the following order (highest priority listed first):
MAC control element (CE) for C-RNTI or data from UL-CCCH;
MAC CE for semi-persistent scheduling (SPS) confirmation;
MAC CE for BSR, with exception of BSR included for padding;
MAC CE for single entry power headroom report (PHR) or multiple entry PHR;
data from any Logical Channel, except data from UL-CCCH;
MAC CE for BSR included for padding.

The Buffer Status reporting (BSR) procedure is used to provide the serving BS with information about UL data volume in the MAC entity. RRC (of the BS) configures the following parameters to control the BSR of the UE:
periodicBSR-Timer;
retxBSR-Timer;
logicalChannelSR-Delay;
logicalChannelSR-DelayTimer;
logicalChannelGroup.

Each logical channel may be allocated to an LCG using the logicalChannelGroup. The maximum number of LCGs may be eight.

The MAC entity determines the amount of UL data available for a logical channel according to the data volume calculation procedure in RLC and PDCP.

In the data volume calculation procedure of RLC, for the purpose of MAC buffer status reporting, the UE considers the following as RLC data volume:
RLC SDUs and RLC SDU segments that have not yet been included in an RLC data PDU;
RLC data PDUs that are pending for initial transmission;
RLC data PDUs that are pending for retransmission (RLC AM).

In the data volume calculation procedure of PDCP, for the purpose of MAC buffer status reporting, the transmitting PDCP entity considers the following as PDCP data volume:
the PDCP SDUs for which no PDCP Data PDUs have been constructed;
the PDCP Data PDUs that have not been submitted to lower layers;
the PDCP Control PDUs;
for AM DRBs, the PDCP SDUs to be retransmitted;
for AM DRBs, the PDCP Data PDUs to be retransmitted.

If the transmitting PDCP entity is associated with two RLC entities, when indicating the PDCP data volume to a MAC entity for BSR triggering and Buffer Size calculation, the transmitting PDCP entity:
if the PDCP duplication is activated:
   indicates the PDCP data volume to the MAC entity associated with the primary RLC entity;
   indicates the PDCP data volume excluding the PDCP Control PDU to the MAC entity associated with the secondary RLC entity;
else:
   if the two associated RLC entities belong to the different Cell Groups; and
   if the total amount of PDCP data volume and RLC data volume pending for initial transmission (as specified in TS 38.322 [5]) in the two associated RLC entities is equal to or larger than ul-DataSplitThreshold:
      indicates the PDCP data volume to both the MAC entity associated with the primary RLC entity and the MAC entity associated with the secondary RLC entity;
   else:
      indicate the PDCP data volume to the MAC entity associated with the primary RLC entity;
      indicate the PDCP data volume as 0 to the MAC entity associated with the secondary RLC entity. ul-DataSplitThreshold is configured by RRC.

In an implementation of the present disclosure, the MAC entity may exclude a logical channel associated with a suspended RLC entity when calculating data volume for an LCG. For example, when the MAC entity calculates buffer size level of an LCG, for each logical channel in the LCG, the MAC entity:
checks whether a logical channel is associated with a suspended RLC entity;
does not calculate the amount of UL data available for a logical channel, which includes data volume calculation of the RLC layer and data volume calculation of the PDCP layer, if the logical channel is associated with a suspended RLC entity;
calculates the amount of UL data available for a logical channel, which includes data volume calculation of the RLC entity associated with the MAC entity and data volume calculation of the PDCP entity associated with the MAC entity, if the logical channel is not associated with a suspended RLC entity;
   add the calculated amount of UL data available for the logical channel to the buffer size of the LCG.

When the MAC entity calculates buffer size level of an LCG, the MAC entity combines the amount of UL data available for all logical channels except for a logical channel associated with a suspended RLC entity in the LCG.

A BSR is triggered if any of the following events occur:
the MAC entity has new UL data available for a logical channel which belongs to an LCG; and either
   the new UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.

For Regular BSR, the MAC entity:

1> if the BSR is triggered for a logical channel for which logicalChannelSR-Delay is configured by upper layers:

2>> starts or restarts the logicalChannelSR-DelayTimer.

1> else:

2>> if running, stops the logicalChannelSR-DelayTimer.

For Regular and Periodic BSR, the MAC entity shall:

1> if more than one LCG has data available for transmission when the BSR is to be transmitted:

2>> reports Long BSR for all LCGs which have data available for transmission.

1> else:

2>> reports Short BSR.

For Padding BSR:

1> if the number of padding bits is equal to or larger than the size of the Short BSR plus its subheader but smaller than the size of the Long BSR plus its subheader:

2>> if more than one LCG has data available for transmission when the BSR is to be transmitted:

3>>> if the number of padding bits is equal to the size of the Short BSR plus its subheader:

4>>>> reports Short Truncated BSR of the LCG with the highest priority logical channel with data available for transmission.

3>>> else:

4>>>> reports Long Truncated BSR of the LCG(s) with the logical channels having data available for transmission following a decreasing order of priority, and in case of equal priority, in increasing order of LCGID.

2>> else:

3>>> reports Short BSR;

1> else if the number of padding bits is equal to or larger than the size of the Long BSR plus its subheader:

2>> reports Long BSR for all LCGs which have data available for transmission.

The MAC entity:

1> if the Buffer Status reporting procedure determines that at least one BSR has been triggered and not cancelled:

2>> if UL-SCH resources are available for a new immediate transmission:

3>>> instruct the Multiplexing and Assembly procedure to generate the BSR MAC CE(s);

3>>> start or restart periodicBSR-Timer except when all the generated BSRs are long or short Truncated BSRs;

3>>> start or restart retxBSR-Timer.

2>> else if a Regular BSR has been triggered and logicalChannelSR-DelayTimer is not running:

3>>> if an uplink grant is not a configured grant; or

3>>> if the Regular BSR was not triggered for a logical channel for which logical channel SR masking (logicalChannelSR-Mask) is setup by upper layers:

4>>>> trigger a Scheduling Request.

A MAC PDU contains at most one BSR MAC CE, even when multiple events have triggered a BSR by the time. The Regular BSR and the Periodic BSR have precedence over the padding BSR.

The MAC entity shall restart retxBSR-Timer upon reception of a grant for transmission of new data on any uplink shared channel (UL-SCH).

All triggered BSRs may be cancelled when the UL grant(s) can accommodate all pending data available for transmission but is not sufficient to additionally accommodate the BSR MAC control element plus its subheader. All triggered BSRs shall be cancelled when a BSR is included in a MAC PDU for transmission.

The MAC entity shall transmit at most one BSR in one MAC PDU. Padding BSR shall not be included when the MAC PDU contains a Regular or Periodic BSR.

FIG. 9 illustrates an implementation example of the present disclosure. In FIG. 9, it is assumed that logical channel (LCH) 2 is associated with a suspended RLC entity as indicated by upper layers. It is also assumed that the calculated amount of UL data available for each logical channel is 100 bytes, which are combined results of data volume calculation of a PDCP entity and data volume calculation of a RLC entity. It is also assumed that all logical channels are included in the logical channel group (LCG) 1.

When the MAC entity receives a UL grant from the BS, the MAC entity performs Selection of logical channels and Allocation of resources.

In Selection of logical channels, the MAC entity selects the LCH 1 for the UL grant; does not select the LCH 2 for the UL grant because LCH 2 is associated with a suspended RLC entity; selects the LCH 3 for the UL grant; and selects the LCH 4 for the UL grant.

In Allocation of resources, the MAC entity allocate the UL grant to LCH 1, 3, and 4 except for LCH 2,

When the MAC entity calculates buffer size level of the LCG 1 during the BSR procedure, the MAC entity:
include the amount of UL data available for the LCH 1, to the buffer size of the LCG (the current buffer size level of the LCG is 100 bytes);
not include the amount of UL data available for the LCH 2 because LCH 2 is associated with a suspended RLC entity (the current buffer size level of the LCG is 100 bytes);
include the amount of UL data available for the LCH 3, to the buffer size of the LCG (the current buffer size level of the LCG is 200 bytes);
include the amount of UL data available for the LCH 4, to the buffer size of the LCG (the current buffer size level of the LCG is 300 bytes).

If the logical channel of the suspended RLC entity can be selected in the LCP procedure, radio resources of an UL grant would be wrongly allocated to the logical channel that cannot transmit any data. It would also cause waste of the UL grant or require another round of LCP procedure. Considering this, in the implementations of the present disclosure, the logical channel of the suspended RLC entity is excluded when the MAC entity performs the LCP procedure.

If the PDCP data volume and RLC data volume of the suspended RLC entity are included in the buffer size calculation, the BSR reports larger amount data than actually can be transmitted. It would cause waste of UL grant. Considering this, in the implementations of the present disclosure, the PDCP/RLC data volume of the suspended RLC entity should be excluded from the buffer size calculation.

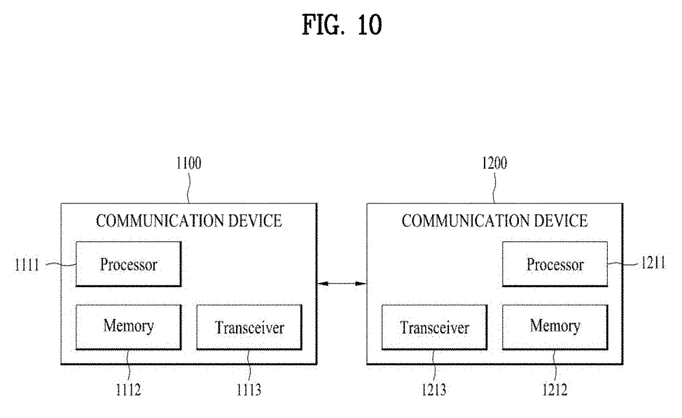

FIG. 10 is a block diagram illustrating examples of communication devices which can perform method(s) of the present disclosure.

In FIG. 10, one of the communication device 1100 and the communication device 1200 may be a user equipment (UE) and the other one mat be a base station (BS). Alternatively, one of the communication device 1100 and the communication device 1200 may be a UE and the other one may be another UE. Alternatively, one of the communication device 1100 and the communication device 1200 may be a network node and the other one may be another network node. In the present disclosure, the network node may be a base station (BS). In some scenarios, the network node may be a core network device (e.g. a network device with a mobility management function, a network device with a session management function, and etc.).

In some scenarios of the present disclosure, either one of the communication devices 1100, 1200, or each of the communication devices 1100, 1200 may be wireless communication device(s) configured to transmit/receive radio signals to/from an external device, or equipped with a wireless communication module to transmit/receive radio signals to/from an external device. The wireless communication module may be a transceiver 1113 or 1213. The wireless communication device is not limited to a UE or a BS, and the wireless communication device may be any suitable mobile computing device that is configured to implement one or more implementations of the present disclosure, such as a vehicular communication system or device, a wearable device, a laptop, a smartphone, and so on. A communication device which is mentioned as a UE or BS in the present disclosure may be replaced by any wireless communication device such as a vehicular communication system or device, a wearable device, a laptop, a smartphone, and so on.

In the present disclosure, communication devices 1100, 1200 include processors 1111, 1211 and memories 1112, 1212. The communication devices 1100 may further include transceivers 1113, 1213 or configured to be operatively connected to transceivers 1113, 1213.

The processor 1111, 1211 implements functions, procedures, and/or methods disclosed in the present disclosure. One or more protocols may be implemented by the processor 1111, 1211. For example, the processor 1111, 1211 may implement one or more layers (e.g., functional layers such as PHY, MAC, RLC, PDCP, RRC, SDAP). The processor 1111, 1211 may generate protocol data units (PDUs) and/or service data units (SDUs) according to functions, procedures, and/or methods disclosed in the present disclosure. The processor 1111, 1211 may generate messages or information according to functions, procedures, and/or methods disclosed in the present disclosure. The processor 1111, 1211 may generate signals (e.g. baseband signals) containing PDUs, SDUs, messages or information according to functions, procedures, and/or methods disclosed in the present disclosure and provide the signals to the transceiver 1113 and/or 1213 connected thereto. The processor 1111, 1211 may receive signals (e.g. baseband signals) from the transceiver 1113, 1213 connected thereto and obtain PDUs, SDUs, messages or information according to functions, procedures, and/or methods disclosed in the present disclosure.

The processor 1111, 1211 may be referred to as controller, microcontroller, microprocessor, or microcomputer. The processor 1111, 1211 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processor 1111, 1211. The present disclosure may be implemented using firmware or software, and the firmware or software may be configured to include modules, procedures, functions, etc. performing the functions or operations of the present disclosure. Firmware or software configured to perform the present disclosure may be included in the processor 1111, 1211 or stored in the memory 1112, 1212 so as to be driven by the processor 1111, 1211.

The memory 1112, 1212 is connected to the processor of the network node and stores various types of PDUs, SDUs, messages, information and/or instructions. The memory 1112, 1212 may be arranged inside or outside the processor 1111, 1211, or may be connected to the processor 1111, 1211 through various techniques, such as wired or wireless connections.

The transceiver 1113, 1213 is connected to the processor 1111, 1211, and may be controlled by the processor 1111, 1211 to transmit and/or receive a signal to/from an external device. The processor 1111, 1211 may control the transceiver 1113, 1213 to initiate communication and to transmit or receive signals including various types of information or data which are transmitted or received through a wired interface or wireless interface. The transceiver 1113, 1213 includes a receiver to receive signals from an external device and transmit signals to an external device. The transceiver 1113, 1213 can up-convert OFDM baseband signals to a carrier frequency under the control of the processor 1111, 1211 and transmit the up-converted OFDM signals at the carrier frequency. The transceiver 1113, 1213 can include an (analog) oscillator, and up-convert the OFDM baseband signals to a carrier frequency by the oscillator. The transceiver 1113, 1213 may receive OFDM signals at a carrier frequency and down-convert the OFDM signals into OFDM baseband signals, under the control of the transceiver 1111, 1211. The transceiver 1113, 1213 may down-convert the OFDM signals with the carrier frequency into the OFDM baseband signals by the oscillator.

In a wireless communication device such as a UE or BS, an antenna facilitates the transmission and reception of radio signals (i.e. wireless signals). In the wireless communication device, the transceiver 1113, 1213 transmits and/or receives a wireless signal such as a radio frequency (RF) signal. For a communication device which is a wireless communication device (e.g. BS or UE), the transceiver 1113, 1213 may be referred to as a radio frequency (RF) unit. In some implementations, the transceiver 1113, 1213 may forward and convert baseband signals provided by the processor 1111, 1211 connected thereto into radio signals with a radio frequency. In the wireless communication device, the transceiver 1113, 1213 may transmit or receive radio signals containing PDUs, SDUs, messages or information according to functions, procedures, and/or methods disclosed in the present disclosure via a radio interface (e.g. time/frequency resources). In some implementations of the present disclosure, upon receiving radio signals with a radio frequency from another communication device, the transceiver 1113, 1213 may forward and convert the radio signals to baseband signals for processing by the processor 1111, 1211. The radio frequency may be referred to as a carrier frequency. In a UE, the processed signals may be processed according to various techniques, such as being transformed into audible or readable information to be output via a speaker of the UE.

In some scenarios of the present disclosure, functions, procedures, and/or methods disclosed in the present disclosure may be implemented by a processing device. The processing device may be a system on chip (SoC). The processing device may include the processor 1111, 1211 and the memory 1112, 1212, and may be mounted on, installed on, or connected to the communication device 1100, 1200. The processing device may be configured to perform or control any one of the methods and/or processes described herein and/or to cause such methods and/or processes to be performed by a communication device which the processing device is mounted on, installed on, or connected to. The memory 1112, 1212 in the processing device may be configured to store software codes including instructions that, when executed by the processor 1111, 1211, causes the processor 1111, 1211 to perform some or all of functions, methods or processes discussed in the present disclosure. The memory 1112, 1212 in the processing device may store or buffer information or data generated by the processor of the processing device or information recovered or obtained by the processor of the processing device. One or more processes involving transmission or reception of the information or data may be performed by the processor 1111, 1211 of the processing device or under control of the processor 1111, 1211 of the processing device. For example, a transceiver 1113, 1213 operably connected or coupled to the processing device may transmit or receive signals containing the information or data under the control of the processor 1111, 1211 of the processing device.

In the implementations of the present disclosure, a UE operates as a transmitting device in uplink (UL) and as a receiving device in downlink (DL). In the implementations of the present disclosure, a BS operates as a receiving device in UL and as a transmitting device in DL. In the present disclosure, a processor, a transceiver, and a memory, which are included in or mounted on a UE, are referred to as a UE processor, a UE transceiver, and a UE memory, respectively, and a processor, a transceiver, and a memory, which are included in or mounted on a BS, are referred to as BS processor, a BS transceiver, and a BS memory, respectively.

The MAC entity according to the implementation(s) of the present disclosure is implemented by the processor 1111, 1211.

The processor 1111, 1211 may be configured with the MAC entity and multiple RLC entities associated with the MAC entity based on RRC signalling of a BS. One of the multiple RLC entities may become suspended due to a reason or event related to the one RLC entity.

When there is an uplink (UL) grant that the processor 1111, 1211 can use, the processor 1111, 1211 performs an LCP procedure for the UL grant. As a part of the LCP procedure, the processor 1111, 1211 selects logical channels related to the UL grant, and allocates resources of the UL grant to the selected logical channels. In the implementations of the present disclosure, the processor 1111, 1211 is configured to exclude logical channel(s) of a suspended RLC entity when performing the LCP procedure. For example, the processor 1111, 1211 is configured to select the logical channels related to the UL grant, only from among only logical channels not related to a suspended radio link control (RLC) entity among RLC entities configured in the processor 1111, 1211. The processor 1111, 1211 is configured to transmit (or control the transceiver 1113, 1213 operably connected to the transceiver to transmit) UL data of the selected logical channels, to which the resources of the UL grant are allocated, on the UL grant. The processor 1111, 1211 may allocate the resources of the UL grant to the selected logical channels in a predefined order of priority. The processor may perform selecting of the logical channels related to the UL grant and allocating of the resources of the UL grant at a medium access control (MAC) entity configured in the processor.

In the implementations of the present disclosure, when calculating data volume for buffer status reporting, the processor 1111, 1211 is configured to exclude logical channel(s) of the suspended RLC entity. For example, the processor 1111, 1211 may determine an amount of UL data available for transmission for a logical channel group (LCG) based on all logical channels of the LCG except for a logical channel related to the suspended RLC entity. The processor 1111, 1211 may transmit (or control the transceiver 1113, 1213 operably connected to the processor 1111, 1211 to transmit) a buffer status report including information on the amount of UL data available for transmission for the LCG. The processor 1111, 1211 may receive an UL grant in response to the buffer status report (via the transceiver 1113, 1213 operably connected to the processor 1111, 1211) from a BS. The processor 1111, 1211 may perform an LCP procedure for the UL grant as described above.

In the implementations of the present disclosure, a logical channel related to the suspended RLC entity may be a logical channel related to a suspended radio bearer, a logical channel related to an RLC entity in which a maximum number of retransmissions has been reached, a logical channel related to an RLC entity perform RLC re-establishment, and/or a logical channel related to a packet data convergence protocol (PDCP) entity performing PDCP re-establishment.

As described above, the detailed description of the preferred implementations of the present disclosure has been given to enable those skilled in the art to implement and practice the disclosure. Although the disclosure has been described with reference to exemplary implementations, those skilled in the art will appreciate that various modifications and variations can be made in the present disclosure without departing from the spirit or scope of the disclosure described in the appended claims. Accordingly, the disclosure should not be limited to the specific implementations described herein, but should be accorded the broadest scope consistent with the principles and novel features disclosed herein.

The implementations of the present disclosure are applicable to a network node (e.g., BS), a UE, or other devices in a wireless communication system.

1. A communication device for transmitting a buffer status report in a wireless communication system, the communication device comprising:
a transceiver, and
a processor configured to control the transceiver, the processor configured to:
determine an amount of uplink (UL) data available for a logical channel group (LCG); and
control the transceiver to transmit the buffer status report including information on the amount of UL data available for the LCG,
wherein the processor is configured to determine the amount of UL data available for the LCG based on all logical channels of the LCG except for a logical channel related to a suspended radio link control (RLC) entity among RLC entities configured for the communication device.

2. The communication device according to claim 1, wherein the logical channel related to the suspended RLC entity comprises a logical channel related to a suspended radio bearer, a logical channel related to an RLC entity in which a maximum number of retransmissions has been reached, a logical channel related to an RLC entity perform RLC re-establishment, or a logical channel related to a packet data convergence protocol (PDCP) entity performing PDCP re-establishment.

3. The communication device according to claim 1, wherein the processor is configured to:
receive an UL grant in response to the buffer status report;
select logical channels related to the UL grant;
allocate resources of the UL grant to the selected logical channels; and
control the transceiver to transmit UL data of the selected logical channels based on the UL grant,
wherein the processor is configured to select the logical channels related to the UL grant among logical channels not related to the suspended RLC entity.

4. The communication device according to claim 3, wherein the processor is configured to allocate the resources of the UL grant to the selected logical channels in a predefined order of priority.

5. The communication device according to claim 3, wherein the processor is configured to:
perform selecting of the logical channels related to the UL grant and allocating of the resources of the UL grant at a medium access control (MAC) entity configured in the processor.

6. A processing device comprising:
at least one processor; and
at least one computer memory that is operably connectable to the at least one processor and that has stored thereon instructions which, when executed, cause the at least one processor to perform operations comprising:
determining an amount of uplink (UL) data available for a logical channel group (LCG); and
transmitting a buffer status report including information on the amount of UL data available for the LCG,
wherein the operations determine the amount of UL data available for the LCG based on all logical channels of the LCG except for a logical channel related to a suspended radio link control (RLC) entity among RLC entities configured in the processing device.

7. The processing device according to claim 6, wherein the logical channel related to the suspended RLC entity comprises a logical channel related to a suspended radio bearer, a logical channel related to an RLC entity in which a maximum number of retransmissions has been reached, a logical channel related to an RLC entity perform RLC re-establishment, or a logical channel related to a packet data convergence protocol (PDCP) entity performing PDCP re-establishment.

8. The processing device according to claim 6, wherein the operations further comprises:
receiving an UL grant in response to the buffer status report;
selecting logical channels related to the UL grant;
allocating resources of the UL grant to the selected logical channels; and
transmitting UL data of the selected logical channels based on the UL grant,
wherein the operations select the logical channels related to the UL grant among logical channels not related to the suspended RLC entity.

9. The processing device according to claim 6, wherein the operations comprises:
allocating the resources of the UL grant to the selected logical channels in a predefined order of priority.

10. The processing device according to claim 6, wherein the operations comprises:
performing selecting of the logical channels related to the UL grant and allocating of the resources of the UL grant at a medium access control (MAC) entity configured in the processing device.

11. A method for transmitting, by a communication device, a buffer status report in a wireless communication system, the method comprising:
determining an amount of uplink (UL) data available for a logical channel group (LCG); and
transmitting the buffer status report including information on the amount of UL data available for the LCG,
wherein the amount of UL data available for the LCG is determined based on all logical channels of the LCG except for a logical channel related to a suspended radio link control (RLC) entity among RLC entities configured for the communication device.

12. The method according to claim 11, wherein the logical channel related to the suspended RLC entity comprises a logical channel related to a suspended radio bearer, a logical channel related to an RLC entity in which a maximum number of retransmissions has been reached, a logical channel related to an RLC entity perform RLC re-establishment, or a logical channel related to a packet data convergence protocol (PDCP) entity performing PDCP re-establishment.

13. The method according to claim 11, further comprising:
receiving an UL grant in response to the buffer status report;
selecting logical channels related to the UL grant;
allocating resources of the UL grant to the selected logical channels; and
transmitting UL data of the selected logical channels based on the UL grant,
wherein the logical channels related to the UL grant are selected from among logical channels not related to the suspended RLC entity.

14. The method according to claim 13, wherein the resources of the UL grant are allocated to the selected logical channels in a predefined order of priority.

15. The method according to claim 13, wherein selecting the logical channels related to the UL grant and allocating the resources of the UL grant are performed at a medium access control (MAC) entity configured in the communication device.
